(19) United States
(12) Patent Application Publication
(10) Pub. No.: US 2014/0284263 A1
(43) Pub. Date: Sep. 25, 2014

(54) Fuel Filter of an Internal Combustion Engine and Filter Element of a Fuel Filter

(71) Applicant: MANN+HUMMEL GMBH, Ludwigsburg (DE)

(72) Inventors: Elke Duerr, Asperg (DE); Martin Veit, Gaertringen (DE); Stefan Eichinger, Gerlingen (DE); Martin Klein, Ludwigsburg (DE)

(21) Appl. No.: 14/298,929

(22) Filed: Jun. 8, 2014

Related U.S. Application Data
(63) Continuation of application No. PCT/EP2012/074969, filed on Dec. 10, 2012.

(30) Foreign Application Priority Data
Dec. 9, 2011 (DE) 10 2011 120 641.1

(51) Int. Cl. B01D 29/58; B01D 35/00

(52) U.S. Cl. CPC B01D 29/58; B01D 35/005
USPC 210/437; 210/435; 210/489

(57) ABSTRACT

A fuel filter has a housing with fuel inlet for fuel to be purified, fuel outlet for purified fuel, and water outlet for water separated from the fuel. A filter element is arranged in the housing and separates seal-tightly fuel inlet from fuel outlet. The filter element has a filter medium formed as a hollow body and flowed through from the interior to the exterior of the filter element or in reverse. A coalescing medium formed as a hollow body is arranged in a flow path of the fuel downstream of the filter medium for separating water from the fuel. The coalescing medium surrounds the filter medium or is arranged in the interior. The coalescing medium has at least one nonwoven layer that coalesces water and has a main orientation of fibers transverse to a main flow path of separated water downstream of the coalescing medium.

### CROSS-REFERENCE TO RELATED APPLICATIONS

This application is a continuation application of international application No. PCT/EP2012/074969 having an international filing date of 10 Dec. 2012 and designating the United States, the international application claiming a priority date of 9 Dec. 2011, based on prior filed German patent application No. 10 2011 120 641.1, the entire contents of the aforesaid international application and the aforesaid German patent application being incorporated herein by reference.

### BACKGROUND OF THE INVENTION

The invention concerns a fuel filter for fuel, in particular diesel fuel, of an internal combustion engine, in particular of a motor vehicle, comprising a housing which comprises at least one fuel inlet for fuel to be purified, at least one fuel outlet for purified fuel, and at least one water outlet for water separated from the fuel, and in which a filter element is arranged that seal-tightly separates the fuel inlet from the fuel outlet and that comprises a filter medium designed as a hollow body that can be flowed through from the interior to the exterior or from the exterior to the interior for filtration of the fuel.

Moreover, the invention concerns a filter element of a fuel filter for fuel, in particular diesel fuel, of an internal combustion engine, in particular of a motor vehicle, that can be arranged in a housing of the fuel filter such that it seal-tightly separates a fuel inlet of the housing from a fuel outlet and that comprises a filter medium designed as a hollow body that is flowed through from the interior to the exterior or from the exterior to the interior for filtration of the fuel.

EP 1 233 173 A2 discloses a liquid filter for fuels as it is used for purification of diesel fuel. The liquid filter has a filter housing with an inflow connector for the diesel fuel to be purified and an outflow connector for purified diesel fuel. Moreover, the liquid filter has a central tube which is used for removal of water that has been separated from the diesel fuel. In the interior of the housing a filter element is arranged in such a way that it is connected between the inflow connector and the outflow connector. The filter element has a star-shaped insert that is flowed through in radial direction from the exterior to the interior. In the upper area of the interior of the star-shaped insert, a separating insert is arranged that has a conical shape. This separating insert is comprised preferably of a water-repellent material in order to improve water separation at the clean side of the star-shaped insert. The diesel fuel to be purified flows via the inflow connector to the dirt side of the filter housing. From here it flows radially from the exterior to the interior through the star-shaped insert and passes in purified form to the clean side. Water droplets that have passed to the clean side in this way sink in the interior of the star-shaped insert in downward direction as a result of their greater density and reach a water storage chamber where the separated water collects. The purified diesel fuel which is flowing in the interior of the star-shaped insert in upward direction passes through the separating insert which significantly assists the water separation due to its water-repellent material. Downstream of the separating insert the diesel fuel passes through the outflow connector out of the filter housing.

The invention has the object to configure a fuel filter and a filter element of a fuel filter of the aforementioned kind in such a way that the filtration of particles from the fuel and the separation of water contained in the fuel are further improved.

### SUMMARY OF THE INVENTION

This object is solved according to the invention in that, in the flow path of the fuel, a coalescing medium designed as a hollow body is arranged downstream of the filter element, surrounding it or within the interior delimited by it, for separating water contained in the fuel. The coalescing medium comprises at least one layer of a nonwoven that is suitable for coalescing water. A main orientation of the fibers of the at least one nonwoven layer extends transverse to a main flow path of the separated water downstream of the coalescing medium.

In particular, a main orientation of the fibers of the nonwoven layer is utilized which results due to the manufacturing process. For example, the fibers, for example, continuous fibers or staple fibers, are placed in a deposition direction onto a support. For example, the deposition direction upon deposition onto a belt is defined by the running direction of the belt. In the deposition process, the fibers are preferably oriented along the deposition direction so that a main orientation of the fibers parallel to the deposition direction results in the thus produced nonwoven.

A main orientation of fibers of a nonwoven layer is not only present at the time when all fibers are extending parallel. In particular, a main orientation of fibers of a nonwoven layer is already present when the extension direction of more than 50% of the fibers has an angle of less than 45° to a direction which is then representing the main orientation, preferably more than 80% of the fibers, even more preferred more than 90% of the fibers.

The orientation of the fibers can be evaluated visually. Quantification can be realized by evaluation of images of light microscope or scanning electron microscope. Particular preferred is the evaluation of micro-tomographic tests by means of X-ray computer tomography for determining the 3D structure of nonwovens and, based thereon, the determination and quantification of the main orientation of the fibers.

According to the invention, the filter element is of a multi-stage configuration. In particular particles that contaminate the fuel are filtered out with the filter medium. At the coalescing medium even smallest water droplets which are contained in the fuel are subsequently combined to larger water drops. In this context, the fine water droplets are retained at the fibers of the nonwoven layer of the coalescing medium and enlarged until they are again entrained by the fuel flow and removed from the coalescing medium. The main orientation of the fibers of the nonwoven layer extends according to the invention transversely to the main flow direction of the separated water downstream of the coalescing medium. The main flow direction of the water downstream of the coalescing medium is substantially predetermined by the force of gravity. The main flow path of the water in the filter element is therefore determined such that in the mounted state of the filter element it extends substantially spatially in vertical direction. The nonwoven layer has a substantially uniform fiber orientation. The main orientation is the mean orientation of the fibers. Due to the orientation of the fibers relative to the main flow direction of the separated water, it is avoided that the water drops, in particular due to the force of gravity, can be transported along the fibers and collect at the edge of the nonwoven layer. A residence time of the water drops on the fibers, in particular where they are being caught, is thus increased. In this way, the separated water drops are concentrated on the fibers and can thus be combined efficiently with further, even smallest, water droplets.

Due to the flow guiding action at the coalescing medium it can be predetermined to which extent the water drops are separated in the coalescing medium and/or downstream thereof. The water drops can be precipitated downstream of the coalescing medium in particular in a precipitation gap. Due to their density they can sink downwardly. The main flow path of the separated water downstream of the coalescing medium is in this case from top to bottom, i.e., vertical. Advantageously, the main orientation of the fibers of the at least one nonwoven layer can be spatially substantially in horizontal direction in relation to the mounted position of the filter element.

With the fuel filter according to the invention also fuels can be purified whose density is greater than that of water in which in analogy water drops will spatially rise to the top. For this purpose, the filter element can be arranged upside down. Accordingly, the fuel inlet, the fuel outlet, and the water outlet can be arranged appropriately. Advantageously, the water can be collected in particular in a water collecting chamber which is connected to the water outlet. The main flow path of the separated water downstream of the coalescing medium is then correspondingly from the bottom to the top. Should it advantageously be provided that the filter medium is flowed through in radial direction from the interior to the exterior, the coalescing medium can be preferably located outside of the filter medium and can surround it. When alternatively it is provided that the filter medium is flowed through in radial direction from the exterior to the interior, the coalescing medium can be located preferably in the interior of the filter medium. The uniform fiber orientation is moreover advantageous in that the nonwoven layer in the fiber direction has a reduced stretchability in comparison to the fiber direction. The nonwoven layer can therefore be stretched stably across an appropriate support frame.

In an advantageous embodiment, the main orientation of the fibers of the at least one nonwoven layer can be substantially transverse to a main flow path of the fuel through the coalescing medium. In this way, it is avoided that the water drops that are caught within the coalescing medium are moved by the fuel flow along the fibers. This has a positive effect on the residence time of the water drops on the fibers and thus on the efficiency of the coalescing action.

In a further advantageous embodiment, in the flow path of the fuel downstream of the coalescing medium, surrounding it or within the interior delimited by it, a hydrophobic and fuel-permeable separating medium that is designed as a hollow body can be arranged for separating water contained in the fuel in such a way that between the coalescing medium and the separating medium a precipitation gap for separated water is realized that is connected to the water outlet of the housing. At the separating medium water drops which are contained in the fuel can be retained. In this way, the water separation can be improved. Advantageously, the separating medium delimits the precipitation gap at the side which is opposite the coalescing medium. The large water drops which are combined by means of the coalescing medium can be precipitated in the flow path of the fuel downstream of the coalescing medium in the precipitation gap. Depending on the density of the fuel, they can sink to the bottom or can rise to the top.

Advantageously, the separating medium can be screen-like. A screen-like, in particular woven, separating medium has the advantage that the water drops are retained on the screen fibers and in particular can drop down or can rise to the top. On a screen-type separating medium the water is optimally retained. The mesh openings of a screen-like fabric can be predetermined in a simple and defined way. It can be designed to be optimally permeable for the fuel. With a screen-like structure the pressure loss at the separating medium can be minimized in a simple way.

Moreover, advantageously the filter medium, the coalescing medium, and optionally the separating medium can be arranged coaxially. A coaxial arrangement is space-saving. Moreover, in a coaxial arrangement a flow course of the fuel from the exterior to the interior in radial direction or from the interior to the exterior in radial direction can be optimized easily. The basic surface of the filter medium, of the coalescing medium, and of the separating medium can be similar in this context. The basic surfaces can however also be different. In particular, they can be round, oval, or angular.

Advantageously, the filter element can be a round filter element. Round filter elements can be designed in a space-saving way. With round filter elements an optimal ratio of filter surface/separating surface relative to the mounting space can be realized.

Moreover, advantageously the housing can be openable and the filter element can be arranged exchangeably in the housing. The filter element can thus be removed easily from the housing for replacement or for servicing purposes.

The object is furthermore solved according to the invention by the filter element in that, in the flow path of the fuel, a coalescing medium embodied a hollow body is arranged downstream of the filter medium, surrounding it or within the interior delimited by it, for separating water contained in the fuel and comprises at least one layer of a nonwoven that is suitable for coalescing water and a main orientation of the fibers of the at least one nonwoven layer is transverse to the main flow path of the water to be separated downstream of the coalescing medium. The advantages and features which have been enumerated in the context of the fuel filter according to the invention apply likewise also to the filter element according to the invention.

### BRIEF DESCRIPTION OF THE DRAWINGS

Further advantages, features and details of the invention result from the following description in which an embodiment of the invention will be explained in more detail with the aid of the drawing. A person of skill in the art will consider the features, disclosed in combination in the drawing, the description, and the claims, also expediently individually and combine them to other meaningful combinations.

FIG. 1 shows a longitudinal section of a fuel filter with an exchangeable three-stage filter element that comprises a coalescing medium with substantially horizontally oriented fibers.

FIG. 2 shows a horizontal section of a detail of the coalescing medium on the left side in FIG. 1.

FIG. 3 shows a detail of the coalescing medium of FIG. 1 looking onto the outflow side.

FIG. 4 a vertical cross-section of a detail of the coalescing medium on the left side in FIG. 1.

In the Figures same components are provided with same reference characters.

### DESCRIPTION OF PREFERRED EMBODIMENTS

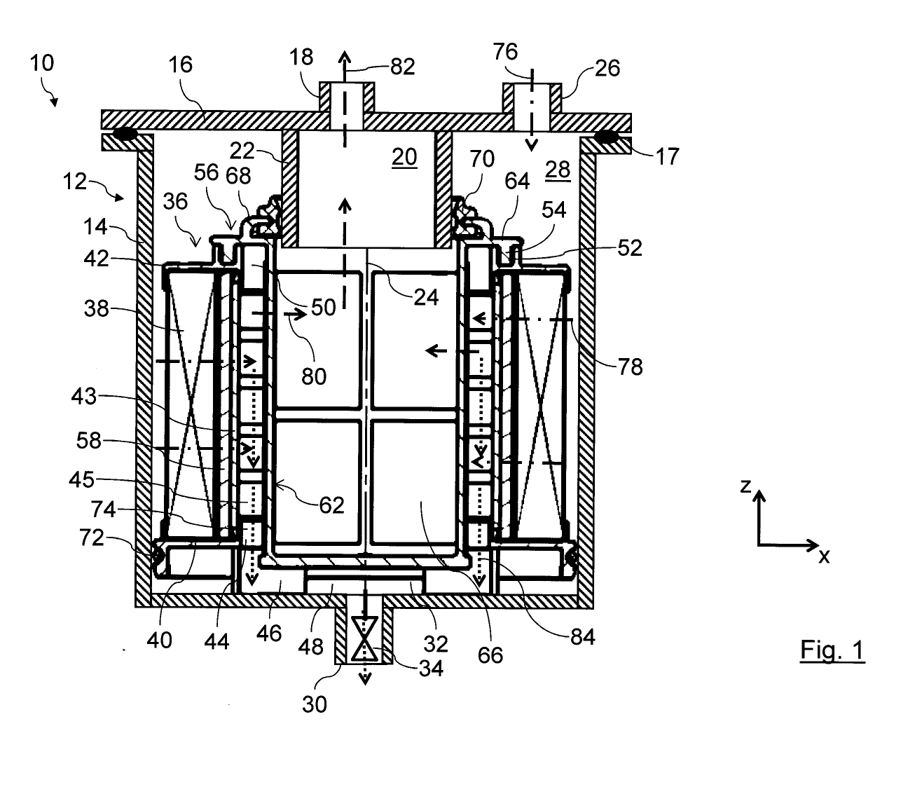

In FIG. 1, in longitudinal section a fuel filter 10 of a fuel filter system of an internal combustion engine of a motor vehicle is shown. The fuel filter 10 serves for purifying the fuel which is employed for operation of the internal combustion engine, for example, diesel fuel. Moreover, the fuel filter serves for separating water that is contained in the fuel.

The fuel filter 10 comprises a two-part housing 12 with a cup-shaped filter cup 14 and a filter cover 16 that is arranged detachably on the filter cup 14. Between the filter cup 14 and the filter cover 16, an annular seal 17 is arranged.

In the cover 16, an outlet socket 18 for the fuel to be purified is approximately centrally arranged which is connected outside of the housing 12 with a fuel outlet line that is not shown in FIG. 1. In the interior of the housing 12, the outlet socket 18 is connected with an outflow chamber 20 in an interior of a connecting socket 22. On the side of the cover 16 which is facing the interior of the housing 12, the connecting socket 22 extends coaxially to a filter axis 24. In the normal mounted position under normal operating conditions of the internal combustion engine, the filter axis 24, as illustrated in FIG. 1, is extending spatially in vertical direction, in the direction of a Z axis which is indicated in FIGS. 1, 3, and 4. “Axial”, “radial”, “coaxial” and “circumferential” refer in the following to the filter axis 24, if not indicated otherwise.

Radially outside of the connecting socket 22, the cover 16 has an inlet socket 26 for the fuel to be purified which is connected with an inflow chamber 28 in the housing 12. Outside of the housing 12, the inlet socket 26 is connected with a fuel supply line for the fuel, not illustrated in FIG. 1.

In the bottom of the filter cup 14, a water drainage socket 30 is arranged coaxially relative to the filter axis 24. The water drainage socket 30 is connected with a water collecting chamber 32 at the bottom in the housing 12. Outside of the housing 12, the water drainage socket 30 is connected with a water drainage line, not illustrated, by means of which water separated from the fuel can be discharged from the housing 12. In the water drainage socket 30 a water drainage valve 34 with the water level sensor is arranged. At rest, the water drain valve 34 is closed so that no liquid can escape from the water collecting chamber 32 through the water drainage socket 30 out of the housing 12. Upon reaching a predetermined maximum water level in the water collecting chamber 32, the water drain valve 34 can be manually or also automatically opened so that the separated water can be drained via the water drainage socket 30.

In the housing 12, an exchangeable filter element 36 is arranged. The filter element 36 is designed as a round filter element. The filter element 36 separates the inlet socket 26 seal-tightly from the outlet socket 18. The filter element 36 comprises a star-shaped folded filter medium 38 with which in particular particles are to be filtered out of the fuel to be purified. The filter medium 38 as a whole has the shape of a coaxial circular cylinder wall. At a lower end face that is facing the bottom of the filter cup 14, the filter medium 38 is connected seal-tightly with a terminating end disk 40. At its opposite end face that is facing the cover 16, the filter medium 38 is connected seal-tightly with a connecting end disk 42. Between the connecting end disk 42 and the terminating end disk 40, a skeletal fluid-permeable central tube 43 extends coaxially in an interior 45 of the filter medium 38 and connects the two end discs 40 and 42 in particular stably with each other.

The terminating end disk 40 has a coaxial opening 44. The opening 44 is surrounded by the central tube 43. The opening 44 connects the interior 45 with the water collecting chamber 32. On the exterior side which is facing the bottom of the filter cup 14, the terminating end disk 40 has several, preferably four, support webs 46 that extend, distributed uniformly, along an imaginary coaxial circular cylinder wall. The imaginary circular cylinder wall surrounds the opening 44 and the water drainage socket 30. With the support webs 46 the filter element 36 is supported at the bottom of the filter cup 14. Between the support webs 46, connecting openings 48 are provided by means of which water in the water collecting chamber 32 can be distributed also in radial direction to the exterior of the support webs 46.

The connecting end disk 42 has a coaxial opening 50. The opening 50 is surrounded by two coaxial projections which extend on the exterior side of the connecting end disk 42 in axial direction. The two projections delimit a receiving groove 52 for an annular insertion web 54 of a separating unit 56 of the filter element 36.

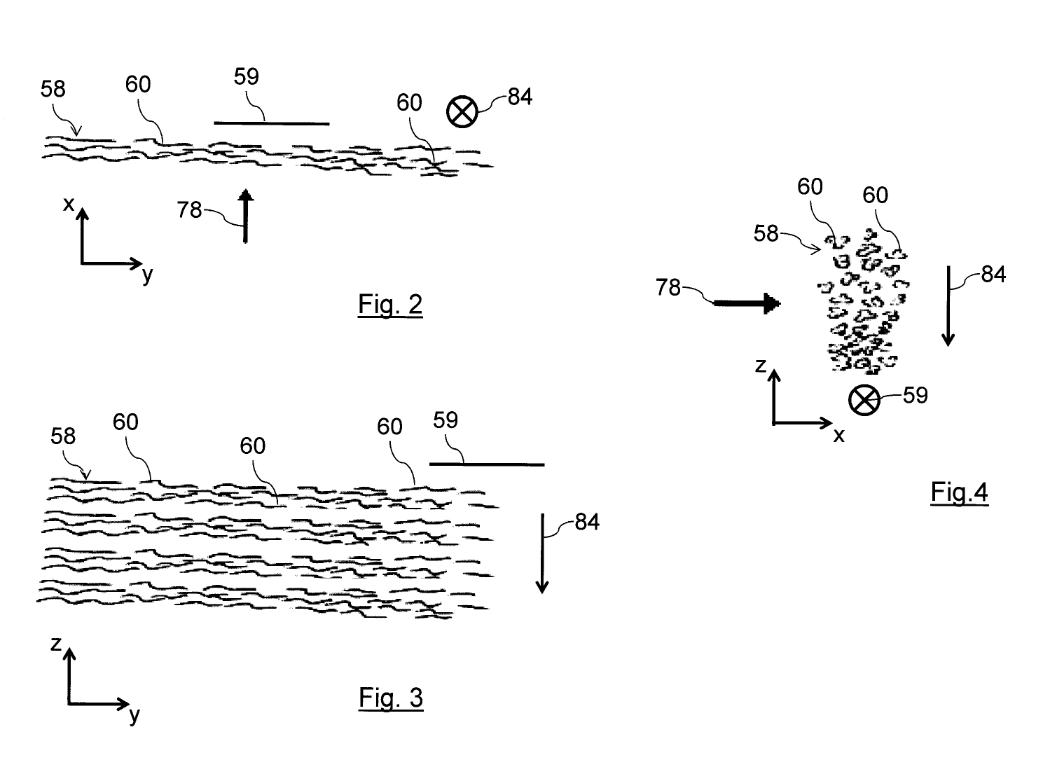

Between the radial inner circumferential side of the filter medium 38 and the central tube 43 there is a coaxial coalescing medium 58. The coalescing medium 58 is a single-layer fiber nonwoven. Alternatively, the fiber nonwoven can also be of a multi-layer configuration. The coalescing medium 58 is circumferentially closed and extends between the connecting end disk 42 and the terminating end disk 40. The coalescing medium 58 serves for combining even smallest water droplets contained in the fuel to greater water drops. The nonwoven layer has a substantially uniform fiber orientation. A main orientation 59 indicated in FIGS. 2 and 3 is the mean orientation of the fibers 60 shown therein. The main orientation 59 of fibers 60 of the coalescing medium 58 extends circumferentially relative to the filter axis 24. In the installed position of the filter element 36, the main orientation 59 of the fibers 60 extends horizontally, indicated by an X-Y plane in the FIGS. 1 to 4. In the cross-sectional illustration of the coalescing medium 58 in FIG. 4, the main orientation 59 extends perpendicular to the drawing plane. In case of a multi-layer fiber nonwoven at least one of the nonwoven layers, preferably all of the nonwoven layers, have a corresponding main orientation.

The separating unit 56 comprises a support cage 62 with a connecting section 64 which comprises also the insertion web 54 and a separating medium 66.

The connecting section 64 is approximately disk-shaped with a coaxial opening into which the connecting socket 22 of the cover 16 projects. On the exterior side which is facing the cover 16 the connecting section 64 has a coaxial connecting socket 68. The connecting socket 68 at its free end face is bent by 90 degrees inwardly in radial direction. On the radial inner rim of the connecting socket 68 a profiled annular seal 70 is positioned. The connecting socket 22 is inserted into the connecting socket 68 such that the connection is sealed with the profiled annular seal 70.

The separating unit 56 is inserted with the separating medium 66 leading axially through the opening 50 of the connecting end disk 42. The support cage 62 and the separating medium 66 are located in the interior which is delimited by the coalescing medium 58, i.e., also within the interior 45 of the filter medium 38.

The separating medium 66 is comprised of a hydrophobic screen fabric. It has the shape of a tube that is coaxial to the filter axis 24. It extends from the connecting end disk 42 to the terminating end disk 40. The separating medium 68 is circumferentially closed.

The circumferential wall of the support cage 62 is of a grid-shaped configuration and is liquid-permeable. On its end face correlated with the connecting socket 22, the support cage 62 is open. The lower end face of the support cage 62 which is facing the water collecting chamber 32 is closed. The separating medium 66 is positioned at the radial outer circumferential side of the support cage 62.

Between the separating medium 66 and the coalescing medium 58, there is a precipitation gap 74 in the interior 45. The precipitation gap 74 has the shape of an annular chamber. The precipitation gap 74 is delimited radially in outward direction by the coalescing medium 58 and radially in inward direction by the separating medium 66.

On the radial outer circumferential side of the connecting end disk 40, there is also an annular seal 72 arranged which is supported in radial outward direction on the radial inwardly facing circumferential side of the filter cup 14. The annular seal 72 seals the inflow chamber 28 relative to the water collecting chamber 32.

Upon operation of the fuel filter 10, the fuel to be purified is supplied from the fuel supply line, indicated by arrow 76, through the inlet socket 26 to the inflow chamber 28.

The fuel flows through the filter medium 38, indicated by arrow 78, from the radial outward raw side of the latter to its radial inward clean side. In doing so, particles are removed from the fuel. The filter medium 38 forms a first stage of the fuel filter 10 for the purification/water separation that, as a whole, has a three-stage configuration.

On the clean side, the fuel from which the particles have been removed passes through the coalescing medium 58 in the radial direction from the exterior to the interior. In this context, water droplets contained in the fuel, even smallest ones, are caught by the fibers 60 of the nonwoven and combined to larger water drops. The fibers 60 are substantially oriented transversely to the flow path of the fuel through the coalescing medium 58. The coalescing medium 58 forms a second stage for the purification/water separation. Due to the orientation of the fibers 60 transverse to the flow direction of the fuel, the residence time of the water drops on the fibers 60 is increased. In this way, the efficiency of the coalescing action is increased. Only when the drop size is sufficient, the large water drops are entrained by the fuel that is passing through. Due to the horizontal orientation of the fibers 60 transverse to the force of gravity, i.e., transverse to a main flow path of the separated water drops in the precipitation gap 74, the residence time of the water drops on the fibers 60 is also increased.

The fuel and the large water drops flow through the openings of the central tube 43 and reach the precipitation gap 47.

The fuel passes the separation medium 66, which is a third stage for the purification/water separation, in radial direction from the exterior to the interior, indicated by arrows 80, and flows upwardly into the outlet chamber 20. The purified fuel from which water has been separated exits the outlet chamber 20 via the outlet socket 18, indicated by arrows 82, and is supplied to the fuel outlet line.

The large water drops, in contrast, are retained by the separating medium 66. They sink in the precipitation gap 74 in downward direction, indicated by arrows 84, into the water collecting chamber 32 due to their greater density in comparison to the fuel.

As soon as the water level sensor of the water drainage valve 34 has detected that the predetermined maximum water level has been reached, the water drainage valve 34 is manually or automatically opened. The water exits from the water collecting chamber 32 through the water drainage socket 30.

For servicing purposes, for example for exchanging or cleaning the filter element 36, the cover 16 is removed in axial direction from the filter cup 14. The filter element 36 is pulled out in axial direction from the filter cup 14.

For installation, the filter element 36 is inserted with the terminating end disk 40 leading in axial direction into the filter cup 14. Subsequently, the cover 16 with the connecting socket 22 leading is inserted in axial direction onto the open side of the filter cup 14 so that the connecting socket 22 projects seal-tightly into the profiled annular seal 70.

With the above-described embodiment of a fuel filter 10 and of a filter element 36 the following modifications are inter alia possible.

The invention is not limited to a fuel filter 10 of an internal combustion engine of a motor vehicle. Instead it can also be utilized for different kinds of internal combustion engines, for example, industrial motors.

Instead of being used for diesel fuel, the fuel filter 10 can also be used for purification/water separation of other types of liquid fuel. If a fuel is used whose density is greater than that of water, the water droplets in analogy will rise. In this case, the filter element 36 can be arranged upside down. The fuel inlet, the fuel outlet, and the water outlet can be arranged appropriately.

The filter medium 38, instead of being folded in a star shape, can also be realized as a different kind of hollow body, for example, not folded.

The filter medium 38, the coalescing medium 58, and/or the separating medium 66, instead of being embodied as a hollow cylinder, can also be realized in a different shape, for example, can be realized as a hollow cone. Instead of having a round basic surface, they can be provided also with a different basic surface, for example, can be oval or angular.

The filter medium 38, the coalescing medium 58, and/or the separating medium 66 can also be arranged in a different way than coaxially relative to each other or to the filter axis 24.

The annular seal 72 can also be eliminated. Preferably, the terminating end disk 40 can be resting tightly at the radial inner circumferential side of the filter cup 14.

Instead of being arranged in the interior 45 of the filter medium 38, the separating medium 66 can be arranged also in radial direction outwardly, surrounding the filter medium 38 and the coalescing medium 58. The fuel to be purified can then flow through the filter medium 38 in radial direction from the interior to the exterior. The coalescing medium 58 can then be arranged preferably also in radial direction outwardly and surround the filter medium 38.

The fuel to be purified, instead of being supplied from above, can also be supplied from below to the raw side of the filter medium 38. The water drainage socket 30, instead of being centrally arranged, can also be eccentrically arranged in the bottom of the filter cup 14.

Instead of the exchangeable filter element 36, also a filter element that is fixedly mounted in the housing 12 can be provided.

While specific embodiments of the invention have been shown and described in detail to illustrate the inventive principles, it will be understood that the invention may be embodied otherwise without departing from such principles.

What is claimed is:

1. A fuel filter for fuel comprising:
a housing comprising at least one fuel inlet for fuel to be purified, at least one fuel outlet for purified fuel, and at least one water outlet for water separated from the fuel;
a filter element arranged in the housing and separating seal-tightly the fuel inlet from the fuel outlet;
the filter element comprising a filter medium configured as a hollow body having an interior and an exterior, the filter element configured to be flowed through from the interior to the exterior or from the exterior to the interior for filtration of the fuel;
the filter element further comprising a coalescing medium configured as a hollow body and arranged in a flow path of the fuel downstream of the filter medium for separating water contained in the fuel;
the coalescing medium surrounding the filter medium or arranged within the interior of the filter medium;
the coalescing medium comprising at least one layer of a nonwoven configured to coalesce water;
the at least one layer of nonwoven having a main orientation of fibers that extends transversely to a main flow path of separated water downstream of the coalescing medium.

2. The fuel filter according to claim 1, wherein the main orientation of the fibers of the at least one layer of nonwoven extends substantially transversely to a main flow path of the fuel through the coalescing medium.

3. The fuel filter according to claim 1, further comprising a hydrophobic fuel-permeable separating medium configured as a hollow body for separating water contained in the fuel, wherein the separating medium surrounds the coalescing medium or is arranged in an interior delimited by the coalescing medium, wherein the separating medium is arranged in a flow path of the fuel downstream of the coalescing medium such that between the coalescing medium and the separating medium a precipitation gap for separated water is realized and the precipitation gap is connected with the water outlet of the housing.

4. The fuel filter according to claim 3, wherein the filter medium, the coalescing medium, and the separating medium are coaxially arranged relative to each other.

5. The fuel filter according to claim 1, wherein the filter medium and the coalescing medium are coaxially arranged relative to each other.

6. The fuel filter according to claim 1, wherein the filter element is a round filter element.

7. The fuel filter according to claim 1, wherein the housing is openable and the filter element is arranged exchangeably in the housing.

8. A filter element of a fuel filter for fuel configured to be arranged in a housing of the fuel filter such that the filter element seal-tightly separates a fuel inlet of the housing from a fuel outlet of the housing; the filter element comprising:
a filter medium configured as a hollow body having an interior and an exterior;
wherein, for filtration of the fuel, the filter medium is configured to be flowed through from the interior to the exterior or from the exterior to the interior;
a coalescing medium configured as a hollow body and arranged in a flow path of the fuel downstream of the filter medium for separation of water contained in the fuel;
wherein the coalescing medium surrounds the filter medium or is arranged within the interior;
wherein the coalescing medium comprises at least one layer of nonwoven configured to coalesce water;
wherein a main orientation of fibers of the at least one layer of nonwoven extends transversely to a main flow path of the separated water downstream of the coalescing medium.
